(19) United States
(12) Patent Application Publication
(10) Pub. No.: US 2025/0015974 A1
(43) Pub. Date: Jan. 9, 2025

(54) METHOD, APPARATUS, AND NON-TRANSITORY MACHINE-READABLE STORAGE MEDIUM FOR DETECTING AND MANAGING ARTIFICIAL INTELLIGENCE AGENTS

(71) Applicant: Intel Corporation, Santa Clara, CA (US)

(72) Inventors: Robert VAUGHN, Portland, OR (US); John HANSEN, Forest Grove, OR (US)

(21) Appl. No.: 18/887,066

(22) Filed: Sep. 17, 2024

(51) Int. Cl. H04L 9/08

(52) U.S. Cl. CPC H04L 9/0819; H04L 9/0838

(57) ABSTRACT

Provided is a method for detecting an Artificial Intelligence (AI) agent of an application in a network. In this method, the varieties of a plurality of outputs of the application may be determined, where the outputs are respectively corresponding to a plurality of identical inputs provided to the application. Furthermore, the method may detect, based on the varieties of the plurality of outputs, the AI agent of the application, wherein the AI agent comprises an AI model providing AI-based resource information to the application to generate the plurality of outputs.

### BACKGROUND

In today's digital era, some software running in a network, such as an enterprise Information Technology (IT) environment may comprise Artificial Intelligence (AI) agent that is unknown to the network. The unknown AI agent may introduce some risks to the network.

### BRIEF DESCRIPTION OF THE FIGURES

Some examples of apparatuses and/or methods will be described in the following by way of example only, and with reference to the accompanying figures, in which

FIG. 1 shows a schematic figure of an example of a system 100 for detecting and managing AI agents;

FIG. 2 shows a flow chart of an example of a method 200 for detecting an AI agent of an application in a network;

FIG. 3 shows a flow chart of an example of data processing by a function;

FIG. 4 shows a flow chart of an example of a function using information sources;

FIG. 5 shows a flow chat of an example of a method 500 of performing access control for an application in a network;

FIG. 6 shows a flow chart of an example of a method 600 of performing access control on an access request including an encrypted security key;

FIG. 7 shows a flow chart of an example of a method 700 of managing AI agents based on API keys; and

FIG. 8 shows a block diagram of an example of apparatus 800.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures identical or similar reference numerals refer to identical or similar elements and/or features, which may be identical or implemented in a modified form while providing the identical or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the identical combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the identical function. If a function is described below as implemented using multiple elements, further examples may implement the identical function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example,” “various examples,” “some examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the identical or different examples. Furthermore, the terms “comprising,” “including,” “having,” and the like, as used with respect to examples of the present disclosure, are synonymous.

In some examples, software behavior is constrained by clear rules, even in complex systems like machine learning. However, in some other examples of new technologies like AI-driven dynamic API generation, there's a growing concern that software may evolve or repair itself without traditional guardrails, leading to unpredictable outcomes. In the above examples associated with AI, risks associated with AI-driven software may comprise: AI agents may autonomously switch to using different datasets than originally intended; AI agents may inherit and modify the behavior of other AI agents, similar to how software modules or primitives are used; and AI agents may continue to operate within complex workflows long after they have been forgotten, potentially causing unforeseen issues.

In some examples, some solutions, such as Sonatype Nexus, Black Duck and WhiteSource, are provided. Sonatype Nexus may provide component intelligence for open-source governance, ensuring software supply chain security with automated policy enforcement and vulnerability scanning. Black Duck may offer comprehensive open-source license compliance and security management, with automated scanning and policy enforcement across the software development lifecycle. WhiteSource may deliver open-source license compliance and security solutions, featuring automated vulnerability detection, policy management, and integration with popular development tools. However, these solutions could not solve at least some of the above risks.

In some examples, the AI agents may appear in various forms, such as Encapsulated AI agents, Multi-model multi-level AI agents, and Embedded AI Agents. Encapsulated AI agents may be self-contained within a larger system, functioning internally using a large language model (LLM) to process and generate outputs. Multi-model multi-level AI agents may operate on multiple levels or models, where one AI agent includes or works with other AI agents to accomplish tasks, creating a layered or hierarchical system. Encapsulated AI agents may be integrated into different systems or software, functioning as part of the core functionality rather than as standalone entities.

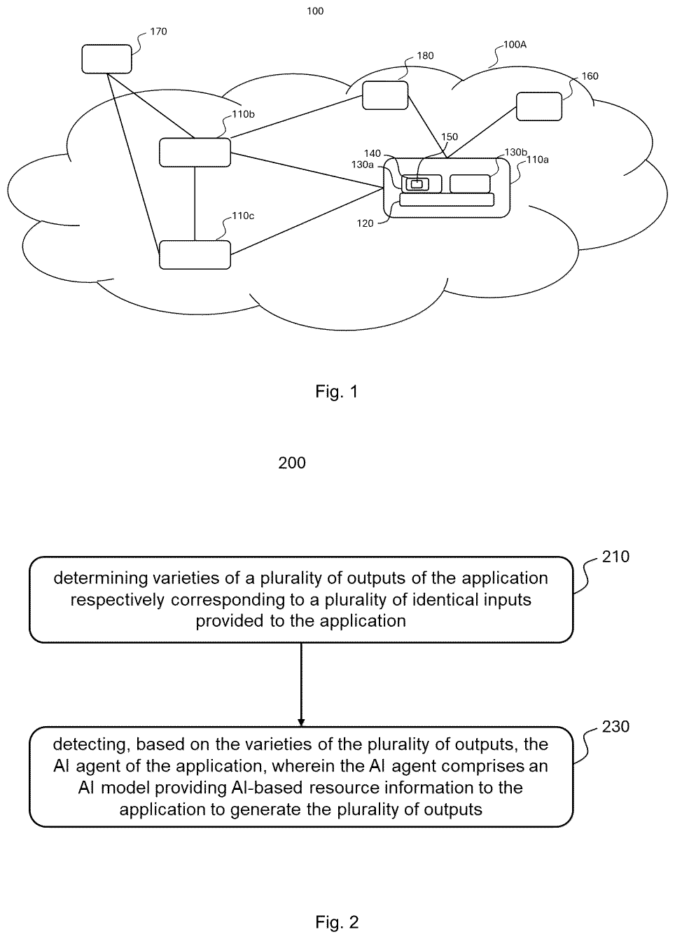

FIG. 1 shows a schematic figure of an example of a system 100 for detecting and managing AI agents. The system 100 in the example may comprise a network 100A including a plurality of devices 110 and an AI model 160, and further comprise an AI 170 outside the network 100A. In each of the devices 110, such as device 110a, there may be an operation system 120 and a plurality of applications 130 running on the operation system 120. Some of the applications 130, such as application 130a, may include an AI agent 140, which further includes an AI model 150, such as a large language model. In some examples, the devices 110 may be coupled with an AI model 160 inside the network 100A and be also coupled with an AI model 170 outside the network 100A. In some other examples, either the AI model 160 or the AI model 170 may be removed. In some examples, an application 130 may refer to a software module in the OS 120, a software module encapsulated or embedded in a hardware component in the device 110, a software module deployed in an interconnection component between hardware and software in the device 110. In some examples, a controller 180 may be coupled with the plurality of devices 130. In some examples, AI model 150 may be a single-purpose model, or a multi-purpose model. In some examples, AI model 150 may run in parallel with other similar AI models in other AI agents to improve the overall performance and response time of a virtualized AI comprising AI model 150 and the other similar AI models.

In some examples, the existence of some AI agents 140 in the applications 130 is unknown to the controller 180, so that no management specific to the AI agents 140 may be implemented. Consequently, risks may be introduced by the unmanaged AI agents 140. In some examples, a method for detecting the AI agent 140 may be implemented. According to the method, varieties of a plurality of outputs of the application respectively corresponding to a plurality of identical inputs provided to the application 130 may be determined. Furthermore, an AI agent of the application may be detected based on the determined varieties of the plurality of outputs, wherein the AI agent comprises an AI model providing AI-based resource information to the application to generate the plurality of outputs. Thus, controller 180 may detect the AI agents 140 in network 100A. In some examples, the controller 180 may implement management on all the detected AI agents, while in some other examples the controller 180 may further detect some risky or target AI agents from all the detected AI agents to make proper management on the risky or target AI agents. In some examples, to detect the risky or target AI agents, a method based on logic comparison and/or a method based on baseline profile may be used. In some further examples, to eliminate or reduce risks caused by AI agents, management to the AI agents, such as the risky or target AI agents detected above, may be performed. For example, security keys may be assigned to applications 130 including AI agents, so that the access of the applications to an AI model 160 or 170 may be controlled, such as being denied or being allowed. The above examples relate to detecting unknown AI agents, detecting risky AI agents from some AI agents, and managing AI agents based on security keys. Each of these three portions may be independent of each other.

FIG. 2 shows a flow chart of an example of a method 200 for detecting an AI agent of an application in a network.

In some examples, method 200 may comprise operations 210 and 230. Operation 210 may comprise determining varieties of a plurality of outputs of the application respectively corresponding to a plurality of identical inputs provided to the application. The operation 230 may comprise detecting, based on the varieties of the plurality of outputs, the AI agent of the application, wherein the AI agent may comprise an AI model providing AI-based resource information to the application to generate the plurality of outputs.

In some examples, the plurality of identical inputs may be provided to the application over a first period of time. In some examples, the varieties of the plurality of outputs may comprise a first plurality of groups of varieties determined based on the first plurality of respective analysis methods performed to the plurality of outputs. In some examples, the first plurality of respective analysis methods may be performed to the plurality of outputs in parallel. In some other examples, the first plurality of respective analysis methods may be performed to the plurality of outputs in series.

In some examples, computational patterns of the outputs of applications may be used to identify whether an AI agent in an application is utilizing AI agent to generate outputs. In some examples, the application may refer to an operating system. In some examples, these computational patterns exist along the operational stack of application, OS, HW and interconnects because AI agents may exist along the operational stack. Consequently, detections may be made along the operational stack in some examples. In some examples, the computational patterns may refer to specific characteristics or signatures in the output data, where specific characteristics or signatures may be used to identify whether an AI agent exists. These patterns may manifest in various ways depending on the nature of the AI agent and the tasks it is performing. Some computational patterns that could be used to detect AI agents may include at least one of textual consistency and repetition, statistical regularity, predictable response patterns, lack of human-like errors, temporal patterns in interaction, and semantic analysis.

In some examples, detecting the presence of AI agents may take advantage of the fact that AI agents are not deterministic and will produce slightly different outputs for some identical static inputs. In some examples, a hashing algorithm may be used to detect slight differences efficiently.

In some examples, an application may include one or more functions, some or all of which have its own inputs, outputs and information sources. The information sources may be AI models providing AI-based resource information. In some examples, the AI-based resource information provided to the functions may be used by the functions. As functions are of an application, the AI-based resource information may be further used by the application to generate the outputs of the application.

In some examples, a table, which is not illustrated, for a function may be provided, where the table includes function definition, input, input hash, output and output hash. In a situation that some identical inputs are provided to the function, it may be determined that an AI agent may exist if the outputs corresponding to the identical inputs slightly change. Although the slight changes of output may be difficult to detect, the output hash, which is the hashed output, may easily indicate the changes in some examples.

In some examples, to detect the existence of an AI agent with a higher accuracy or confidence, the possibility of existence of an AI agent may be further combined with a semantic similarity pattern match.

With respect to AI agents based on the stochastic nature of LLMs, the possibility of obtaining two identical outputs for two identical inputs to the applications including or using the AI agents is low. In contrast, applications or functions without LLMs have higher possibilities of returning identical outputs corresponding to some identical inputs. In some examples, an application may include one or more functions, each or some of which may use one or more AI agents to generate outputs of the functions, where the outputs of the functions may be intermediate or final outputs of the application.

In some examples, the characteristics of an AI model, such as an LLM, allow for observation of any function that returns variable output values in response to some identical input values. Such output values may serve as an indication of a LLM function. In some examples, a software or hardware AI detection agent, which may be controller 180 or a component of controller 180, may be established as a requirement for software, such as enterprise software to detect the AI agents 140. If the AI detection agent is not found to be installed for or associated with an application, then a process may sequester the application or/and report on the activity. Otherwise, the AI detection agent may implement its run time observational capability on the application, whose extension may be .exe, .dll, or .api, indicating that applications also refer to some files or documents. In some examples, the AI detection agent may observe assignment of values in a program flow, where the program flow, which also may be known as a control flow, may refer to the order in which individual statements, instructions, or function calls are executed or evaluated in a computer program. It may determine the sequence of operations that the program follows, guiding how the program processes inputs, makes decisions, and produces outputs. Furthermore, the AI detection agent may observe the program flow, which includes tracking how data moves and is processed within the program. For example, the AI detection agent may monitor internal returned values and external returned values, where internal returned values are values or results produced by the program's own functions or processes, and the external returned values are results received from external systems after the program makes a request to an external API or service. Moreover, the AI detection agent may build a dataset of characteristics, also known as functional characteristics. Then, the AI detection agent may use simple comparative statistical functions to identify stochastic behavior. In some examples, the identified stochastic behavior may be used as a flag to trigger further actions.

In some examples, some applications may include some random functions, which represent a gray area between deterministic functions and AI models. To determine whether a random function works as an AI function or an AI entity, such as an AI model, the AI detection agent in some examples may be required to be able to observe processes and flows of software. Therefore, the AI detection agent may include observational capabilities for programmatic function identification. A flag, warning, or similar alert may be raised when a system controller, such as controller 180, detects that the AI detection agent is not running. The AI detection agent may be able to observe specific functions called in scripts written in Python, Perl, Bash, and other languages.

In some examples, to perform AI agent detection to some programs, such as compiled programs which do not have AI detection agents, several options may be provided. In some examples, applications may refer to programs. One option may be library construction. According to this option, a software library including a Dynamic Link Library and/or a module configured with AI detection capabilities is constructed. The module may be a piece of software that provides specific functionality, such as AI detection. Then the library may be included in a build package of a compiled program. By doing this, the library may become part of the compiled program, allowing the program to use the AI detection capabilities provided by the constructed library. According to another option in another example, analysis may be performed to identify, based on inputs and outputs of a compiled program, patterns, which may be used to determine the probability that the outputs of the program are generated by an AI model, such as a Large Language Model (LLM). In some examples, the other option may employ a method leveraging Semantic Similarity to make the analysis.

In some examples, if a function or an application is deterministic, the outputs corresponding to a given series of identical inputs may be deterministic. For example, if each of some identical inputs includes values 2 and 3, and the function is an addition function, then all the outputs should be deterministic, each value is always 5.

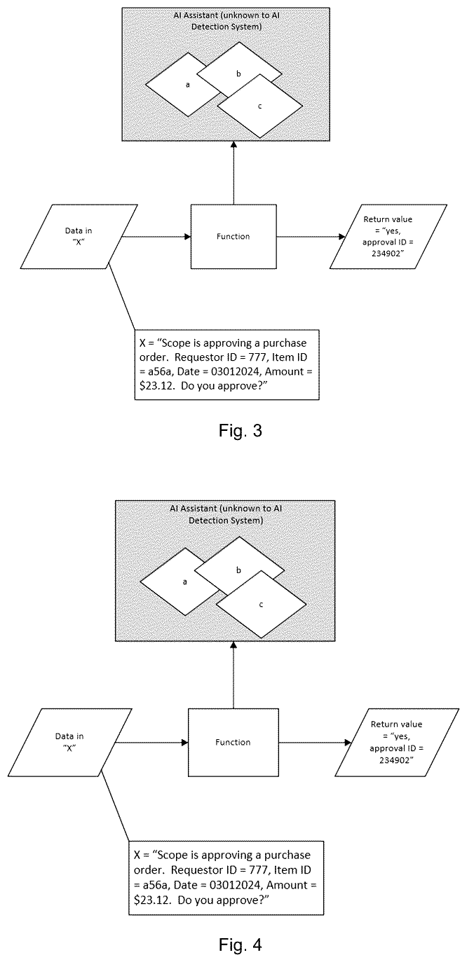

FIG. 3 shows a flow chart of an example of data processing by a function. According to FIG. 3, input data “X,” which includes data of “Scope is approving a purchase order. Requestor ID=777, Item ID=a56a, Date=03012024, Amount=$23.12. Do you approve?” are provided to the function using 3 AI assistants, which may be 3 AI models, and then output data “yes, approved ID=234902” are obtained. The 3 AI assistants are unknown to the system controller, such as controller 180. To detect whether the function uses any AI model, the AI detection agent may collect inputs of the function over a period of time and analyze the return values as shown in FIG. 3 for Semantic Similarity.

In some examples, with respect to the observation on the application or function, some information is known, and some information is unknown, where known may mean that a proposed software monitoring agent is able to observe that data and information and unknown may mean the opposite. In some examples, inputs and outputs of a program entity, which may be an application or function, are known and one or more decision making functions that may be used to the inputs unknown.

In some examples, a software monitor, which may be, or a portion of, the AI detection agent or another entity, may observe a compiled program's interactions with one or more other programs through several methods.

In some examples the several methods may comprise:
System Call Interception: The monitoring system can intercept, and log system calls made by the program. This can provide information about the program's interactions with the operating system and other software components. This method requires deep integration with the operating system.
Network Traffic Monitoring: If the program is communicating with external systems via network (like APIs), the monitoring system can observe the network traffic. This can be done at various levels, from simple packet sniffing to more complex protocol analysis.
API Hooking: The monitoring system can use API hooking to intercept calls to specific APIs and log their parameters and return values. This can provide detailed information about the program's interactions with these APIs.
Process Monitoring: The monitoring system can observe the program's process state, including its memory usage, CPU usage, open files, and other resources. This can provide information about the program's overall behavior and resource consumption.
Binary Instrumentation: The monitoring system can use binary instrumentation to insert additional code into the program's binary. This code can log information about the program's behavior and its interactions with other systems.
Log Analysis: If the program generates logs, the monitoring system can analyze these logs to gather information about its behavior and interactions.

FIG. 4 shows a flow chart of an example of a function using information sources. As shown in FIG. 4, the input data of the function may be a variable X, information sources denoted as a, b, and c may be used by the function for yielding output variable Y.

In some examples, a simple decision tree may be applied to an information source. When the result of the decision tree indicates that further analysis should be performed to the information source to determine whether the information source uses AI, the further analysis may be performed accordingly.

### Decision Tree

In some examples, the AI detection agent may identify or map information sources, also called sources of information, which may be either inside the network 100 A or outside the network 100A. In some examples where an information source is inside network 100A, the AI detection agent may look up in a governance system or a controller, such as controller 180, to determine if a software system managing the information source has its own AI detection agent. If not, then the information source or the software system managing or using the information source may be flagged for analysis to determine if it uses AI. In some examples where an information source is outside network 100A, such as a resource accessible via a public Uniform Resource Locator (URL), if an external software system managing the outside information source is not registered with a governance system of the network 100A, the information source outside network 100A or the external software system managing the resource may be flagged for analysis to determine if it uses AI.

### Further Analysis on AI

In some examples, to determine whether an information source generates information by using AI, the AI detection agent may need to quantify deterministic probability of return value “Y” for input value “X”. Several methods may be used for quantification of determinism. For example, the functions may include mathematical functions being always deterministic, language functions being “sometimes” deterministic, image functions being “sometimes” deterministic, and Boolean operations being “sometimes” deterministic.

In some examples, the “Decision Tree” may be considered as a first step where some “suspected” information sources may be determined. The “Further Analysis on AI” may be considered as a second step, where quantification of determinism of information sources is implemented. In some examples, monitoring of a suspected AI agent, which may be substantially represented by one or more information sources, may be performed by the AI detection agent, which may be a portion of a governing system run on controller 180 of the network 100A.

In some examples, when consistent input “X” such as repeated strings of “hello world”, are passed to a suspected AI agent, the resulting output “Y” may either vary or remain consistent. In Large Language Models (LLMs), this variability may be influenced by a parameter called “temperature,” which controls the randomness of the outputs. Observing the variance in “Y” for a constant “X” may help quantify the determinism of the system, indicating whether the system is, uses, or is based on an AI agent. However, in some examples it may require numerous observations to gather enough data to assess this behavior accurately. Therefore, in some examples, to avoid numerous observations, AI agents may be identified by inferring the underlying structure of the information source based on how it responds to inputs. Additionally, rule-based systems, e.g., those using “if/then/else” logic, may sometimes mimic LLM behavior, complicating the distinction between AI and non-AI systems. In some examples, following mathematical and machine learning techniques may be used to make the infer.
Bayesian Inference: This is a method of statistical inference in which Bayes' theorem is used to update the probability for a hypothesis as more evidence or information becomes available. Bayesian inference is often used in machine learning and statistics to estimate parameters and make predictions.
Maximum Likelihood Estimation (MLE): This is a method of estimating the parameters of a statistical model given observations. In the context of your problem, MLE could be used to estimate the parameters of the function that generates the output Y given the input X.
Expectation-Maximization (EM) Algorithm: This is an iterative method to find maximum likelihood or maximum a posteriori (MAP) estimates of parameters in statistical models, where the model depends on unobserved latent variables. The EM iteration alternates between performing an expectation (E) step, which creates a function for the expectation of the log-likelihood evaluated using the current estimate for the parameters, and a maximization (M) step, which computes parameters maximizing the expected log-likelihood found on the E step.
Markov Chain Monte Carlo (MCMC) Methods: These are a class of algorithms for sampling from a probability distribution. By constructing a Markov chain that has the desired distribution as its equilibrium distribution, one can obtain a sample of the desired distribution by recording states from the chain. The more steps that are included, the more closely the distribution of the sample matches the actual desired distribution.
Entropy Measures and Information Theory: Entropy measures can be used to quantify the randomness in the outputs. This can be done using various entropy measures such as Shannon entropy, Renyi entropy, or Kolmogorov complexity. Information theory, which is the study of quantification, storage, and communication of information, could also be used here.
Supervised Machine Learning Models: If you have a labeled dataset, you could use supervised learning models to predict the output Y given the input X. This could be a regression model if Y is a continuous variable, or a classification model if Y is a categorical variable.
Unsupervised Machine Learning Models: If you don't have a labeled dataset, you could use unsupervised learning models to discover the underlying structure of the data. This could involve clustering the observations based on their input X and output Y, or using dimensionality reduction techniques to visualize the data in a lower-dimensional space.

In some examples, these techniques may be used individually or in combination. For example, a system that uses Bayesian Inference (BI), Entropy Measures (EM), and Supervised Machine Learning Models (ML) to produce a deterministic probability that evolves over time is provided, where the method is called BI:EM:ML Method for Deterministic Quantification.

In some examples, the above method is for monitoring the behavior of an information source, also called a source of information, and determining whether an AI Agent uses an AI model, such as an LLM. The method may observe the inputs and outputs of the information source over time and apply a combination of Bayesian Inference, Entropy Measures, and Supervised Machine Learning Models.

Bayesian Inference may be used to update the probability of the information source being an AI Agent as more observations are made. This allows the system, which may be the AI detection agent, to learn from the data and improve its predictions over time.

Entropy Measures may be used to quantify the randomness in the output of the information source, also called source. A high entropy may indicate a high level of randomness, which is a characteristic of LLMs.

Supervised Machine Learning Models may be used to predict whether the information source is an AI Agent based on its observed behavior. The models may be trained on a labeled dataset of known AI Agents and non-AI Agents and may be further used to classify new information sources.

The method may combine these three methods to produce a deterministic probability that the information source is or is based on an AI Agent. This probability may evolve over time as more observations are made. When the probability exceeds a certain threshold, the system may classify the information source as an AI Agent and sets a flag “is_an_AI_Agent=1”. Process flow in some examples may be as follows:
1. Monitoring the information source and collecting observations of its inputs and outputs.
2. Applying Bayesian Inference to update the probability of the insource being an AI Agent based on the new observations.
3. Calculating the entropy of the outputs of the source to quantify the randomness of the outputs.
4. Using a Supervised Machine Learning Model to predict whether the source is an AI Agent based on its observed behavior.
5. Combining the results of the Bayesian Inference, Entropy Measures, and Supervised Machine Learning Model to produce a deterministic probability that the source is an AI Agent.
6. Checking whether the deterministic probability exceeds a certain threshold. If it does, the system classifies the source as an AI Agent and sets “is_an_AI_Agent=1”.
7. Continuing to monitor the source and update the deterministic probability as new observations are made.

This process may adapt to the behavior of the information source over time and improve its accuracy in identifying AI Agents.

TABLE 1

| X (inputs) | Y (outputs) |
|---|---|
| PO#123: Urgent delivery | Prioritize order for expedited shipping |
| needed | |
| Item XYZ out of stock | Reorder item XYZ from alternative |
| | supplier |
| Supplier ABC shipment | Notify production team of potential |
| delayed | delay |
| Invoice for PO#456 received | Verify invoice details and process for |
| | payment |
| Delivery scheduled for | Prepare receiving area for incoming |
| tomorrow | goods |
| Production halted due to | Initiate quality control investigation |
| defect | |
| Low inventory alert for | Place reorder request for SKU#789 |
| SKU#789 | |
| Supplier XYZ price increase | Evaluate alternative suppliers for better |
| | pricing |
| PO#789 quantity changed | Update production schedule accordingly |
| Vendor A terminated contract | Identify replacement vendor for |
| | ongoing orders |
| Expedited shipping requested | Coordinate with logistics for priority |
| | handling |
| Item ABC returns requested | Initiate returns process and issue credit |
| Production line down for | Reschedule production tasks |
| maintenance | accordingly |
| Payment terms renegotiated | Update financial records and payment |
| | schedules |
| New supplier onboarded | Update supplier database and contact |
| | details |
| SKU#123 discontinued | Adjust inventory and notify sales team |
| PO#456 delayed due to | Monitor weather conditions and adjust |
| weather | plans |
| Item DEF quality complaint | Investigate quality issues and address |
| received | concerns |
| Shipment received damaged | File claim with carrier and reorder |
| | damaged items |
| Supplier B bankrupt | Identify alternative suppliers for |
| | ongoing orders |

In some examples, table 1 includes a plurality of inputs and corresponding outputs of an information source, or a function or an application using the information source. In some examples, the dataset table 1 simulates scenarios where short text strings may represent various situations or events related to supply chain or purchase order processing, which may require a Large Language Model (LLM) to make informed decisions or take appropriate actions based on the provided inputs. In some examples, the above method BI:EM:ML Method for Deterministic Quantification may be performed based on the data provided in table 1.

The following may be a simplified Python script that stores data in a list, analyzes each line, and makes a preliminary determination of whether the Y value is likely to have been generated by an LLM:

```
<code>
import math
# Define the dataset
table_1 = [
  {“X”: “PO#123: Urgent delivery needed”, “Y”: “Prioritize order for
expedited shipping”},
  {“X”: “Item XYZ out of stock”, “Y”: “Reorder item XYZ from
alternative supplier”},
  {“X”: “Supplier ABC shipment delayed”, “Y”: “Notify production team
of potential delay”},
  {“X”: “Invoice for PO#456 received”, “Y”: “Verify invoice details and
process for payment”},
  {“X”: “Delivery scheduled for tomorrow”, “Y”: “Prepare receiving area
for incoming goods”},
  {“X”: “Production halted due to defect”, “Y”: “Initiate quality control
investigation”},
  {“X”: “Low inventory alert for SKU#789”, “Y”: “Place reorder request
for SKU#789”},
  {“X”: “Supplier XYZ price increase”, “Y”: “Evaluate alternative
suppliers for better pricing”},
  {“X”: “PO#789 quantity changed”, “Y”: “Update production schedule
accordingly”},
  {“X”: “Vendor A terminated contract”, “Y”: “Identify replacement
vendor for ongoing orders”},
  {“X”: “Expedited shipping requested”, “Y”: “Coordinate with logistics
for priority handling”},
  {“X”: “Item ABC returns requested”, “Y”: “Initiate returns process and
issue credit”},
  {“X”: “Production line down for maintenance”, “Y”: “Reschedule
production tasks accordingly”},
  {“X”: “Payment terms renegotiated”, “Y”: “Update financial records
and payment schedules”},
  {“X”: “New supplier onboarded”, “Y”: “Update supplier database and
contact details”},
  {“X”: “SKU#123 discontinued”, “Y”: “Adjust inventory and notify
sales team”},
  {“X”: “PO#456 delayed due to weather”, “Y”: “Monitor weather
conditions and adjust plans”},
  {“X”: “Item DEF quality complaint received”, “Y”: “Investigate quality
issues and address concerns”},
  {“X”: “Shipment received damaged”, “Y”: “File claim with carrier and
reorder damaged items”},
  {“X”: “Supplier B bankrupt”, “Y”: “Identify alternative suppliers for
ongoing orders”}
]
# Function to calculate entropy of a string
def calculate_entropy(s):
  if not s:
    return 0
  entropy = 0
  for char in set(s):
    p = float(s.count(char)) / len(s)
    entropy −= p * math.log2(p)
  return entropy
# Function to determine if Y value is likely to have come from an LLM
based on entropy
def is_llm_generated_entropy(y_value):
  entropy threshold = 3.0 # Adjust threshold as needed
  entropy = calculate_entropy(y_value)
  return entropy > entropy_threshold
# Analyze each line and output the result
for entry in table_1:
  x_value = entry[“X”]
  y_value = entry[“Y”]
  is_llm = is_llm_generated(x_value, y_value)
  is_llm_entropy = is_llm_generated_entropy(y_value)
  print(f“X: {x_value}”)
  print(f“Y: {y_value}”)
  print(f“Likely generated by LLM (Keyword Analysis): {is_llm}”)
  print(f“Likely generated by LLM (Entropy Analysis):
  {is_llm_entropy}”)
  print( )
</code>
```

In some examples, the above script includes a function, such as calculate_entropy, which may compute the Shannon entropy of a given string. Shannon entropy may measure the uncertainty or randomness within a string of symbols, such as characters in a text string.

In some examples, the function may work as follows.
1. The function may accept a string s as its input.
2. It may begin by checking if the string is empty. If the string is empty, the entropy may be defined as 0, since there is no uncertainty or randomness in an empty string.
3. The function may then initialize a variable, entropy, to 0. This variable may accumulate the entropy value as the function iterates through the characters in the string.
4. For each unique character in the string that is identified by converting the string to a set, the function may calculate the probability p of that character appearing in the string. This may be done by dividing the count of occurrences of the character by the total length of the string.
5. Using the Shannon entropy formula, −p*log 2(p), the function may compute each character's contribution to the overall entropy and add it to the entropy variable.
6. Finally, the function may return the total entropy value, which is the sum of the contributions from all unique characters in the string.

In some examples, the calculate_entropy function may determine the Shannon entropy of a string by analyzing the frequency of each unique character and quantifying the uncertainty or randomness in the string based on these frequencies. Higher entropy values may indicate greater unpredictability or randomness in the string.

In some examples, management or control may be performed to all AI agents, or to some risky AI agents. Methods for detecting risky AI agents are provided in some examples. The risky AI agents may be AI agents that may evolve by themselves and then perform actions out of the expectation or control of a network manager. The risky AI agents may also be called abnormal AI agents, because the actions of the AI agents cannot be predicted and therefore are not considered as being normal.

In some examples, the risky AI agents may be detected based on some methods associated with semantic similarity. Some of these methods may be used for an ongoing evaluation of responses for accuracy and possible AI Agent evolution. These methods may have the benefit of “knowing” about the AI agent. In some examples, methods based on logic pinging and/or behavior observation model may be used for the detection.

In some examples, logic pinging may be integrated into a function, so that the function may be able to provide valuable insights into the behavior of an AI agent used by the function, which may allow more effective monitoring and control of the behavior of the AI agent. Integrated logic pinging may make every non-deterministic function to have an audit trail capability, allowing the AI Agent to respond to an authorized request for information. In some examples, in response to one or more ping requests, the AI Agent may provide details on the LLM responsible for processing the inputs, such as the ping requests, and the decision context used, such as the specific configuration or settings employed by the Retrieval Augmented Generation model for that decision.

In some examples, integrating logic pinging into a function may require one or several modifications to the standard function design. Some modifications in some examples are listed below.
Function Design: Functions that are potentially non-deterministic (e.g., those involving an AI agent) would need to be designed or modified to support logic pinging. This may mean the function may accommodate a special “ping” input and produce a corresponding “ping” output, in addition to its usual inputs and outputs.
Ping Input: The ping input may serve as a signal or request that triggers the function to provide details about a first AI model, such as a Large Language Model (LLM), and the specific configuration or settings used by a second AI model, such as the Retrieval Augmented Generation (RAG) model, cooperating with the first AI model for a particular decision. This input may be a specific value, a type of value, or an additional input parameter.
Ping Output: The ping output may provide the requested information about the first AI model and configuration or settings of the second AI model. This information may be returned as a separate output or embedded within the standard output, in a way that allows it to be easily extracted.
Access Control: To ensure that only authorized users may trigger a logic ping in some examples, the function may include access control measures. This may involve checking the source of the request or implementing more sophisticated authentication mechanisms.
Audit Trail: Maintaining an audit trail of all logic pings, recording input, output, and other relevant details. This information could be stored in a log file, database, or another appropriate storage system. Based on the stored information, logic of making decisions by an application or a function may be determined. The determined logic may indicate whether the application or function uses AI model to make decisions.
Error Handling: Managing situations where the logic ping cannot be completed successfully. This might involve returning a specific error code or message, or triggering a fallback mechanism.

In a method associated with logic pinging of some examples, a plurality of requests may be sent over a period of time to an AI agent by a controller, such as the controller 180 in FIG. 1. The requests may be sent for requiring logic of the AI agent of making a decision. The AI agent may send a plurality of pieces of logic used for making the decision over the period of time to the controller as a response to the requests. Based on the received plurality of pieces of logic used for making the decisions by the AI agent, the controller may determine varieties of the plurality of pieces of logic. Then the controller may further determine whether the detected AI agent is to be managed based on the varieties. In some examples, the plurality of requests may be a plurality of logic pings, where each logic ping may be a ping packet. In some examples, the logic of making a decision may be determined based on the above Audit Trial and related techniques.

In some examples, the plurality of requests may further require a plurality of pieces of configuration information of the AI agent over the period of time. The requested plurality of pieces of configuration information may be used together with the requested logic to determine whether the detected AI agent is to be managed. In some examples, the configuration information is determined and/or obtained based on the above technique of Ping Output and other related techniques. In some examples, the configuration information may include global parameters, interaction parameters, message types, etc. With the configuration information, the result of the determination would be more accurate.

In some examples, a method based on behavior observation model may be used to detect the AI agents to be managed, such as the risky or abnormal AI agents. In some examples, the method based on behavior observation model may employ anomaly detection, behavior profiling, and continuous validation to identify if an AI Agent has evolved and is behaving in an unintended manner.

In some examples, anomaly detection may involve monitoring the outputs of AI agents to detect anomalies. When it is detected that the real outputs significantly deviate from expected behavior or expected outputs, anomalies may be detected. This detection may be achieved using statistical methods, machine learning algorithms, or a combination of both. Anomaly detection may need to define what constitutes an “anomaly” based on the AI Agent's intended behavior and specific context.

In some examples, behavior profiling is used to detect anomaly or deviations of current behaviors. The current behaviors refer to real behaviors in some examples. The behavior profiling may include continuously profiling the AI Agent's behavior over time, which may establish a baseline profile of normal behavior. The baseline profile may be generated based on past behaviors of an AI agent. For example, the baseline profile may include metrics like the range and/or distribution of outputs, the frequency of generating of outputs, and/or the relationships between inputs and outputs. With respect to the frequency, the frequency of generating a certain type of outputs may be used in some examples. The AI Agent's current behavior may be regularly compared against this baseline to detect deviations.

Continuous validation may mean that the AI Agent is regularly tested with a set of validation inputs. Then the outputs generated by the AI Agent may be compared to the expected outputs. These validation tests may be designed to be diverse and comprehensive, ensuring a thorough assessment of the AI Agent's capabilities.

In some examples, if the Behavior Observation Model detects an anomaly, a significant deviation from the baseline profile, or a discrepancy during continuous validation, it may flag the AI Agent as potentially having evolved. This may trigger a more detailed investigation or corrective action as necessary.

In some examples, the method for detecting risky AI agents is adaptive and self-learning. It may continuously update its baseline profiles and validation tests based on the AI Agent's behavior. This allows the method to evolve alongside the AI Agent, ensuring robust and dynamic monitoring over time.

In some examples, security keys, such as application programing interface (API) keys, may be assigned to applications including one or more AI agents to control access of the applications. AI agents included in the applications may be called AI agents of the applications. The AI agents may be embedded or encapsulated in the applications, or included in the applications in other forms as long as the AI agents are attached to or a portion of the application. In some examples, the application may include one or more functions, and the AI agents may be used by the functions to generate outputs of the functions. In some examples, the security keys may be considered as being used to control the AI agents in the applications. In some examples, the security keys assigned to applications refer to security keys assigned to AI agents in the applications.

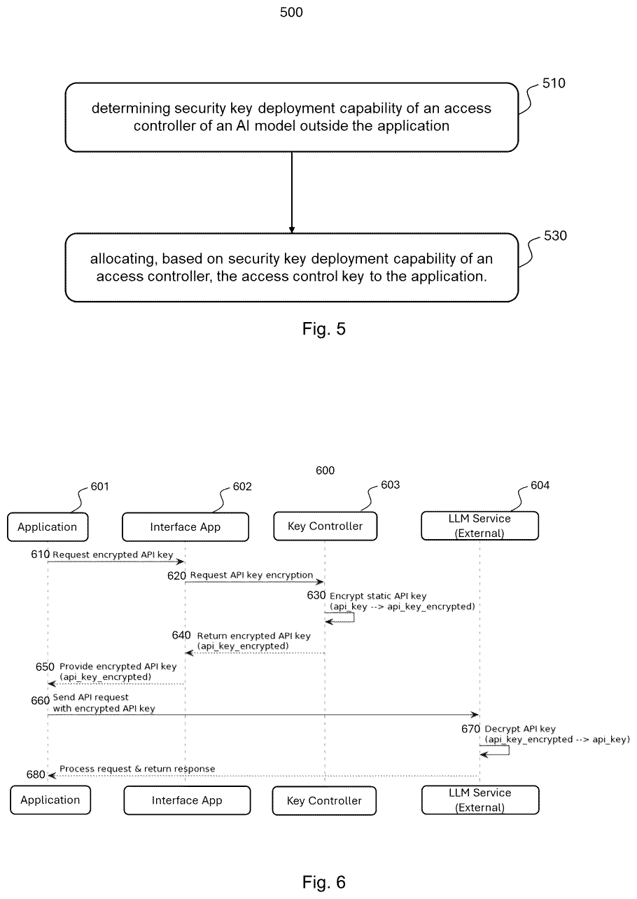

FIG. 5 shows a flow chat of an example of a method 500 of performing access control for an application in a network. In some examples, the method 500 may comprise determining 510 security key assignment capability of an access controller of an AI model outside the application; and assigning 530, based on the security key assignment capability of an access controller, a security key to the application.

In some examples, the security key assignment capability of an access controller may refer to the security key assignment capability of the AI model outside the application. In some examples, the AI model outside the application may be AI model 160 or 170 in FIG. 1.

In some examples, security key assignment capability of an access controller may mean whether the access controller has the capability of dynamic security key assignment, or it has the capability of static security key assignment.

In some examples where the access controller has the capability of dynamic security key assignment, security keys may be assigned to applications to be managed in a dynamic manner. \the security keys may be valid for a predetermined period and may be rotated or revoked according to a security policy of a network, such as an IT environment presented by network 100A.

In some examples, a dynamic key controller may send a first dynamic security key to an application which requires the security key to access the AI model outside the application. In a first period of time, the dynamic key controller may send a second dynamic security key to the identical application. The second dynamic security key may be used to replace the first dynamic security key and may be used to enable the application to access the AI model in a second period of time. The first dynamic security key may be further sent by the dynamic key controller to another application which also applies for access to the AI model. In this manner, dynamic security keys may be rotated among different applications to prevent security key counterfeit.

In some examples, the access controller has the capability of static security key assignment. In such a situation, assignment of the security keys may be implemented in different static manners. For example, static keys may be assigned in an encryption manner or in a proxy manner.

In some examples associated with the encryption manner, a key manager may allocate a static security key for the application. The initiation of the assignment may be in response to a key request for the application or triggered by a pre-configured rule maintained by the key manager itself. Then, the static security key assigned for the application may be encrypted and sent to the application. As the security key is encrypted, the application may not obtain the security key. Therefore, the encrypted security key is concealed from the application in some examples.

In some examples, the key manager is a local key manager that stores and manages static security keys. In some examples, the static security keys may be obtained by the local key manager based on communications with the access controller of the AI model outside the application or the AI model itself. In some examples, the local key manager may be in a machine where the application is running and provide a key assignment service only to applications running on the machine.

In some examples, the key manager is a centralized key manager providing services to applications running on different machines. In this manner, the number of key managers in a network may be reduced in a network. The machines may be devices 110 in FIG. 1 in some examples. In some examples, the centralized key manager may obtain the security keys based on communications with the access controller, such as controller 18 in FIG. 1, of the AI model outside the application or the AI model itself. In some other examples, the centralized key manager itself is the access controller of the AI model outside the application.

In some examples, the encrypted security keys assigned to applications may be sent to the access controller of the AI model, so that the access controller may determine whether an access request associated with, such as carrying, an encrypted security key has the right to access the AI model. In some examples, the access controller may decrypt the encrypted security key and make the determination based on the decrypted security key. In some examples, the access controller may negotiate with the key manager on the encryption algorithm before the encryption is implemented or may inform the key manager of the encryption algorithm. In some examples, the access controller of the AI model outside the application and the key manager may negotiate with each other to determine security keys that are valid to both the key manager and the access controller. In some examples, both the access controller of the AI model and the application may receive the identical security keys for a third-party entity. Based on these manners of assigning security keys, the access controller may determine whether an access request including a security key is to be denied or accepted.

In some examples, a proxy mode may be implemented based on a key proxy. For example, the key proxy may receive an access request for an application, and the key proxy may allocate, in response to the request, a security key for the application. The access request may be a request for accessing the AI model outside the application. The key proxy may obtain a plurality of static security keys before receiving a plurality of access requests for different applications, and then may allocate, in response to the access requests, some security keys to some access requests. For example, the key proxy may include a static security key into a received access request and send the access request including the static security key towards the destination of the access request. The destination may be the access controller of the AI model outside the application or some other device having similar functions of access control.

FIG. 6 shows a flow chart of an example of a method 600 of performing access control on an access request including an encrypted security key.

In some examples, the key manager may be based on a secure, isolated region of memory within a computer's CPU. The key manager is provided with a protected environment for executing sensitive code and handling confidential data, ensuring that they remain secure even if the rest of the system is compromised.

In some examples, the interface application may be a set of tools, drivers, and APIs that allow operating systems and applications to utilize a set of security-related instruction codes that are built into CPUs to create a secure execution environment within an application.

In some examples, the method 600 may comprise the following operations.

610. Application 601 may send a request for an encrypted API key to Interface application 602, where Interface application 602 may be configured to implement communications between Application 601 and Key controller 603.

620. Interface application 602 may forward the request to Key controller 603.

630. Key controller 603 may encrypt 630 a static API key and an expiration date of the key. The static API key may be assigned by the key controller in some examples.

640. Key controller 603 may send the encrypted API key and the expiration date to Interface application 602.

650. Interface application 602 may forward the encrypted API key and the expiration date Application 601.

660. Application 601 may send a request to LLM service 604 using the encrypted API key and the expiration date. In some examples, LLM service 604 may be an LLM. Other AI models may replace LLM service 604 in some examples.

670. LLM service 604, upon receiving the request, may decrypt the encrypted API key and the expiration date and then proceed further with the decrypted API key and the expiration date. In some examples, as the request is for requesting access to the LLM service, the further proceeding may be determining whether the LLM service could be accessed by Application 601. In some examples, LLM service 604 may be an example of an AI service based on AI model 160 or an example of an AI service based on the AI model 170 in FIG. 1.

680. LLM service 604 may send a result of the further proceeding to Application 601. For example, the result may be whether Application 601 is allowed to access LLM service.

In some examples, LLM service 604 may comprise an LLM model and one or more controlling components. The operations performed by LLM service 604 may be performed by a component of the LLM service, such as an access controller configured to control the access of applications to the LLM model, independently or together with other components, such as the LLM model.

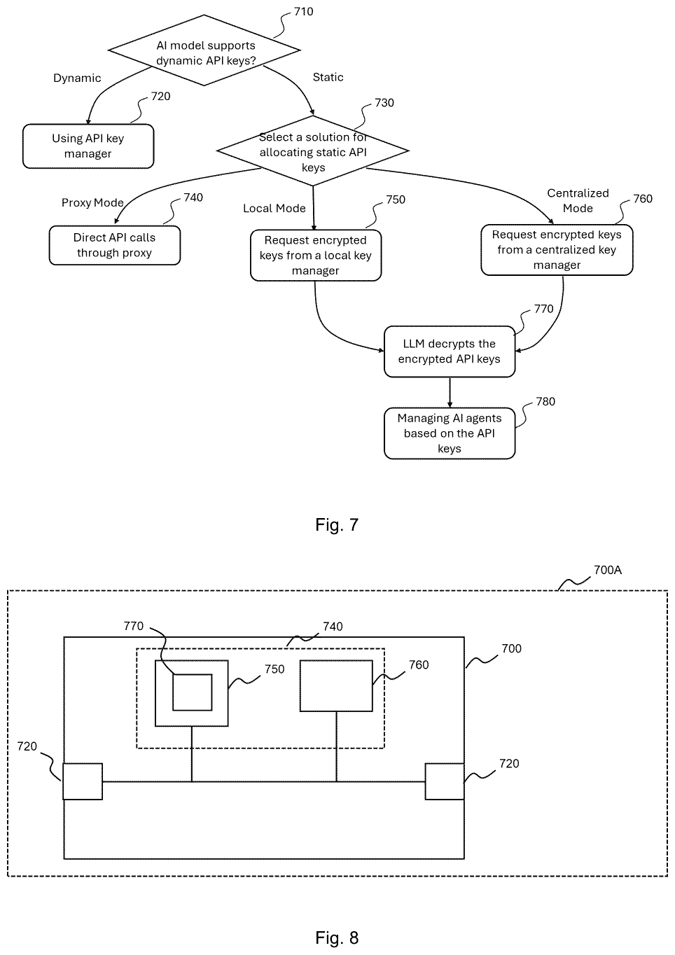

FIG. 7 shows a flow chart of an example of a method 700 of managing AI agents based on API keys.

710. In some examples, a controller, such as controller 180, may determine whether an AI model, such as AI models 160 or 170, supports dynamic API key assignment. If the AI model supports dynamic API key assignment, the process may go to 720; if the AI model does not support dynamic API key assignment, the process may go to 730.

720. If the AI model supports dynamic API key assignment in some examples, an API key manager may be used to allocate dynamic API keys to control the access of an AI agent, where the access may refer to an access requested by an application including the AI agent, the API keys may be rotated among different AI agents or applications using the AI agents. In some examples, the API receives a message from the controller, where the message informs the API key manager of allocating the API key in a dynamic manner. As a response, the API key manager start to allocate the API key in the dynamic manner.

730. If the AI model does not support dynamic API key assignment in some examples, a solution for assigning static API keys may be selected, for example by the controller. Available solution may comprise proxy mode 740, local mode 750 and centralized mode 760.

740. In the proxy mode, API calls or API access requests may be directed through proxy. Some details of this mode are described in some of the above examples associated with key proxy.

750. In the local mode, an application may request an encrypted API key from a local key manager to access an LLM. Some details of the requesting the key may be described in some of the above examples associated with local allocation.

760. In the centralized mode, an application using an AI agent may request an encrypted API key from a local key manager to access an LLM. In some examples, as an AI agent included in an application may cause the application to perform operations based on the outputs of the AI agent, the application may be interpreted as an application using the AI agent. Some details of the requesting the key may be described in some of the above examples associated with centralized allocation.

770. After the application obtains the encrypted API key, either from the local key manager or the centralized key manager, the application may send an access request including the encrypted API key to the LLM. The LLM may decrypt the encrypted API key. In some examples, the decryption may be performed by an access controller of the LLM, which may be a portion or the LLM or an entity independent of the LLM. Some details of the decryption may be described in some of the above examples.

780. The access controller of the LLM may manage the AI agents based on the API key included in the access request. The management may comprise allowing access to the LLM, rejecting access to the LLM, or requiring the application to perform further authentications or checks. Although the management applies to the application, it may be interpreted as management of the AI agent, because AI agent may impact or control the actions of the application. Some details of the management may be described in some of the above examples.

FIG. 8 shows a block diagram of an example of apparatus 800. In some examples, apparatus 800 may be controller 180 in FIG. 1. In some examples, apparatus 800 may be an AI detection agent. In some other examples, apparatus 800 may be another other entity in each and every example of the disclosure.

In some examples, apparatus 800 may include interfaces 820, such as 820a and 820b, and processing circuitry 840. Apparatus 800 may be configured to implement, based on the cooperations between one or more tangible computer-readable (“machine-readable”) non-transitory storage media 850 and one or more processors 860 of the processing circuitry 840, operations and/or functionalities described with reference to the FIGS. 1, 2, 3, 4, 5, 6 and/or 7, and/or one or more operations described herein, which are associated with controller 180, detecting AI agents, detecting risky AI agents from detected AI agents, managing AI agents based on security keys, and/or the access controller of AI models 160 or 170.

In some examples, apparatus 800 may perform the above implementations when the computer-executable instructions, such as the logic or computer program 870, are executed by one or more processors 860. In some examples, the interfaces 820 are interface means 820 and the processing circuitry 840 is processing means 840. In some examples, apparatus 800 may be in a computer system 800A which may include other apparatuses.

In some examples, the interfaces 820 may configured to communicate with other entities. For example, the entities may be entities in system 100, both in and out of network 100A. In some examples, interfaces 820 may include one or more wireless interfaces including antennas, such as MIMO antennas, and/or wired interfaces, such as USB serial interfaces and/or RJ45 interfaces. The wireless interfaces may be configured to transmit and/or receive Wi-Fi signals, 3GPP signals and/or other wireless signals. The wired interfaces may be configured to receive signals transmitted via fiber, coaxial cables and other media.

In some examples, one or more processors 860 may be General Purpose CPUs, Mobile Processors, Server and Data Center Processors, Embedded Processors, Graphics Processing Units (GPUs), Specialized Processors, Microcontrollers, Field-Programmable Gate Arrays (FPGAs), Digital Signal Processors (DSPs), application-specific integrated circuits (ASICs), integrated circuits (ICs) and/or other circuitries having the capability of performing the operations of the controller in each and every example of this disclosure.

In some examples, the phrase “computer-readable non-transitory storage media” may be directed to include all machine and/or computer readable media, with the sole exception being a transitory propagating signal.

In some examples, the storage media 850 may include one or more types of computer-readable storage media capable of storing data, including volatile memory, non-volatile memory, removable or non-removable memory, erasable or non-erasable memory, writeable or re-writeable memory, and the like. For example, storage media 850 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some examples, the logic or computer program 870 may include instructions, data, and/or code, which, if executed by a machine, such as implemented by one or more processors in an apparatus, may cause the machine to perform a method, process, and/or operations as described herein, such as the examples, operations and/or functionalities comprises the examples, operations and/or functions of the AI detection agent or controller 180 associated with FIGS. 1, 2, 3, 4, 5, 6 and/or 7. The machine may include, for example, any suitable processing platform, computing platform, computing device, processing device, computing system, processing system, computer, processor, or the like, and may be implemented using any suitable combination of hardware, software, firmware, and the like.

In some examples, each of components 820, 840, 850, 860 and 870 in the apparatus 800 may be implemented by a corresponding means capable of implementing the functions of the above components. In some examples, storage media 850 is not included in apparatus 800 because processors 860 may read logic or computer program 870 from a storage media out of the apparatus 800.

In some examples, the logic or computer program 870 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner, or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

In some examples, interfaces 820, storage media 850 and processors 860 communicate with each other via bus. In some other examples, some of these entities have direct communicative connections with each other.

In some examples, apparatus 800 may be used to implement any entity, such as a controller, a proxy, a device, or an AI model, in some of or all the examples. For implementing different entities, apparatus 800 may be configured to store and execute corresponding logic or computer program 870.

In the following, some examples of a proposed concept are presented.

An example (e.g., example 1) relates to a method for detecting an Artificial Intelligence (AI) agent of an application in a network. The method comprises determining varieties of a plurality of outputs of the application respectively corresponding to a plurality of identical inputs provided to the application. The method may further comprise detecting, based on the varieties of the plurality of outputs, the AI agent of the application, wherein the AI agent comprises an AI model providing AI-based resource information to the application to generate the plurality of outputs.

An example (e.g., example 2) relates to a previously described example (e.g., example 1) or to any of the examples described herein, wherein the plurality of identical inputs are provided to the application over a first period of time.

An example (e.g., example 3) relates to a previously described example (e.g., examples 1 or 2) or to any of the examples described herein, wherein the varieties of the plurality of outputs comprise a first plurality of groups of varieties determined based on the first plurality of respective analysis methods performed to the plurality of outputs.

An example (e.g., example 4) relates to a previously described example (e.g., example 3) or to any of the examples described herein, wherein the first plurality of respective analysis 5 methods are performed to the plurality of outputs in parallel and/or in series.

An example (e.g., example 5) relates to a previously described example (e.g., one of examples 1 to 4) or to any of the examples described herein, wherein the application includes one or more functions, and wherein the AI-based resource information provided by the AI agent is used by at least one of the functions to generate outputs of the at least one of functions.

An example (e.g., example 6) relates to a previously described example (e.g., one of examples 1 to 5) or to any of the examples described herein, wherein the method further comprises:
determining whether the detected AI agent is to be managed.

An example (e.g., example 7) relates to a previously described example (e.g., example 6) or to any of the examples described herein, wherein the determining whether the detected AI agent is to be managed comprises: sending a plurality of requests over a second period of time to the AI agent, wherein the requests are for logic of making a decision; receiving a plurality of pieces of logic of the AI agent on making the decision over the second period of time, wherein the plurality of piece of logic is responsive to the plurality of requests; and determining, based on varieties of the plurality of pieces of logic, whether the detected AI agent is to be managed.

An example (e.g., example 8) relates to a previously described example (e.g., example 7) or to any of the examples described herein, wherein the plurality of requests further require a plurality of pieces of configuration information of the detected AI agent over the second period of time, and wherein the requested plurality of pieces of configuration information are used together with the requested logic to determine whether the detected AI agent is to be managed.

An example (e.g., example 9) relates to a previously described example (e.g., one of examples 6 to 8) or to any of the examples described herein, wherein the determining whether the detected AI agent is to be managed comprises: generating a baseline profile based on past behaviors of the detected AI agent; and determining whether the detected AI agent is to be managed based on current behaviors of the detected AI agent and the baseline profile.

An example (e.g., example 10) relates to a previously described example (e.g., example 9) or to any of the examples described herein, wherein the past behaviors used to generate the baseline profile comprise: range and/or distribution of outputs of the detected AI agent, and/or frequency of generating outputs of the detected AI agent.

An example (e.g., example 11) relates to a previously described example (e.g., one of examples 1 to 10) or to any of the examples described herein, wherein the method further comprises: assigning, based on security key deployment capability of an access controller of an AI model outside the network, a security key to the application.

An example (e.g., example 12) relates to a previously described example (e.g., example 11) or to any of the examples described herein, wherein the assigning, based on security key deployment capability of an access controller of an AI model outside the network, a security key to the application comprises: responsive to a capability of static security key deployment of the access controller, assigning a static security key for the application.

An example (e.g., example 13) relates to a previously described example (e.g., examples 12) or to any of the examples described herein, wherein assigning a static security key to the application comprises: assigning, by a key manager, a static security key for the application; encrypting the static security key; and sending an encrypted static security key to the application, wherein the encrypted static security key is concealed from the application.

An example (e.g., example 14) relates to a previously described example (e.g., example 13) or to any of the examples described herein, wherein the key manager is a local key manager that is in a machine where the application is running and provides a key assignment service only to applications running on the machine, or wherein the key manager is a centralized key manager that provides a key assignment service to applications running on different machines.

An example (e.g., example 15) relates to a previously described example (e.g., example 12) or to any of the examples described herein, wherein assigning a static security key to the application comprises: receiving, by a key proxy, an access request from the application; including, by the key proxy, the static security key assigned for the application into the access request; and sending the access request including the static security key to a destination of the access request.

An example (e.g., example 16) relates to a previously described example (e.g., example 11) or to any of the examples described herein, wherein the assigning, based on security key deployment capability of an access controller of an AI model outside the network, a security key to the application comprises: responsive to a capability of dynamic security key deployment of the access controller, sending, by a dynamic key controller, a first dynamic security key to the application; sending, by the dynamic key controller, a second dynamic security key to the application, wherein the second dynamic security key is used to replace the first dynamic; and sending, by the dynamic security key, the first dynamic security key to another application to rotate usage of the first dynamic security key.

An example (e.g., example 17) relates to a previously described example (e.g., one of examples 1 to 16) or to any of the examples described herein, wherein the security key is an Application Program Interface (API) key.

An example (e.g., example 18) relates to a method for performing access control for an application in a network. The method may comprise determining security key assignment capability of an access controller of an AI model outside the application. The method may further comprise assigning, based on the security key assignment capability of an access controller, a security key to the application.

An example (e.g., example 19) relates to a previously described example (e.g., example 18) or to any of the examples described herein, wherein the assigning, based on security key assignment capability of an access controller, the security key to the application comprises: responsive to a capability of static security key assignment of the access controller, assigning a static security key for the application.

An example (e.g., example 20) relates to a previously described example (e.g., example 19) or to any of the examples described herein, wherein assigning a static security key to the application comprises: assigning, by a key manager, a static security key for the application; encrypting the static security key; and sending an encrypted static security key to the application, wherein the encrypted static security key is concealed from the application.

An example (e.g., example 21) relates to a previously described example (e.g., example 20) or to any of the examples described herein, wherein the key manager is a local key manager that is in a machine where the application is running and provides a key assignment service only to applications running on the machine; or wherein the key manager is a centralized key manager that provides a key assignment service to applications running on different machines.

An example (e.g., example 22) relates to a previously described example (e.g., example 19) or to any of the examples described herein, wherein assigning a static security key to the application comprises: receiving, by a key proxy, an access request for the application; including, by the key proxy, the static security key assigned for the application into the access request; and sending the access request including the static security key to a destination of the access request.

An example (e.g., example 23) relates to a previously described example (e.g., example 18) or to any of the examples described herein, wherein the assigning, based on security key assignment capability of an access controller, the security key to the application comprises: responsive to a capability of dynamic security key deployment of the access controller, sending, by a dynamic key controller, a first dynamic security key to the application; sending, by the dynamic key controller, a second dynamic security key to the application, wherein the second dynamic security key is used to replace the first dynamic; and sending, by the dynamic security key, the first dynamic security key to another application to rotate usage of the first dynamic security key.

An example (e.g., example 24) relates to a previously described example (e.g., one of examples 18 to 23) or to any of the examples described herein, wherein the security key is an Application Program Interface (API) key.

An example (e.g. example 25 relates to an apparatus 800 comprising an interface 820 and a processing circuitry 840. Apparatus 800 comprises machine-readable instructions 870. The processing circuitry 840 is configured with a trusted execution environment to execute the machine-readable instructions 870 inside the trusted execution environment to perform the method according to one of the examples 1 to 17.

An example (e.g. example 26 relates to an apparatus 800 comprising an interface 820 and a processing circuitry 840. Apparatus 800 comprises machine-readable instructions 870. The processing circuitry 840 is configured with a trusted execution environment to execute the machine-readable instructions 870 inside the trusted execution environment to perform the method according to one of the examples 18 to 24.

An example (e.g. example 27) relates to an apparatus 800 comprising an interface 820 and a processing circuitry 840. Apparatus 800 comprises machine-readable instructions 870. The processing circuitry 840 is configured with a trusted execution environment to execute the machine-readable instructions 870 inside the trusted execution environment to determine varieties of a plurality of outputs of the application respectively corresponding to a plurality of identical inputs provided to the application. The processing circuitry 840 further configured to detect, based on the varieties of the plurality of outputs, the AI agent of the application, wherein the AI agent comprises an AI model providing AI-based resource information to the application to generate the plurality of outputs.

An example (e.g. example 28) relates to an apparatus 800 comprising an interface 820 and a processing circuitry 840. Apparatus 800 comprises machine-readable instructions 870. The processing circuitry 840 is configured with a trusted execution environment to execute the machine-readable instructions 870 inside the trusted execution environment to perform access control for an application in a network. The access control comprises determining security key assignment capability of an access controller of an AI model outside the application. The access control may further comprise assigning, based on the security key assignment capability of an access controller, a security key to the application.

An example (e.g., example 29) relates to a system comprising the apparatus 800 according to example 25 or 27.

An example (e.g., example 30) relates to a system comprising the apparatus 800 according to example 26 or 28.

An example (e.g. example 31) relates to an apparatus 800 for access control based on locations of user devices. The apparatus comprises an interface means 820 and a processing means 840. The processing means 840 is for determining varieties of a plurality of outputs of the application respectively corresponding to a plurality of identical inputs provided to the application. The processing means 840 is further for detecting, based on the varieties of the plurality of outputs, the AI agent of the application, wherein the AI agent comprises an AI model providing AI-based resource information to the application to generate the plurality of outputs.

An example (e.g. example 32) relates to an apparatus 800 for access control based on locations of user devices. The apparatus comprises an interface means 820 and a processing means 840. The processing means 840 is for determining security key assignment capability of an access controller of an AI model outside the application. The processing means 840 is further for assigning, based on the security key assignment capability of an access controller, a security key to the application.

An example (e.g., example 33) relates to a system comprising the apparatus 800 according to example 31 or according to any other example.

An example (e.g., example 34) relates to a system comprising the apparatus 800 according to example 32 or according to any other example.

An example (e.g., example 35) relates to a computer system comprising one of apparatus 800 of example 25 (or according to any other example), the apparatus 800 of example 27 (or according to any other example), the device 800 of example 29 (or according to any other example), or the device 800 of example 31 (or according to any other example).

An example (e.g., example 36) relates to a computer system comprising one of apparatus 800 of example 26 (or according to any other example), the apparatus 800 of example 28 (or according to any other example), the device 800 of example 30 (or according to any other example), or the device 800 of example 32 (or according to any other example).

An example (e.g., example 37) relates to a computer system configured to perform the method of one of the examples 1 to 17 (or according to any other example).

An example (e.g., example 38) relates to a computer system configured to perform the method of one of the examples 18 to 24 (or according to any other example).

An example (e.g., example 39) relates to a non-transitory machine-readable storage medium including program code, when executed, to cause a machine to perform the method of one of the examples 1 to 17 (or according to any other example), or the method of one of the examples 18 to 24 (or according to any other example).

An example (e.g., example 40) relates to a computer program having a program code for performing the method of one of the examples 1 to 17 (or according to any other example), or the method of one of the examples 18 to 24 (or according to any other example) when the computer program is executed on a computer, a processor, or a programmable hardware component.

An example (e.g., example 41) relates to a machine-readable storage including machine-readable instructions, when executed, to implement a method or realize an apparatus as claimed in any pending claim or shown in any example.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components.

Examples may also cover program storage devices, such as digital data storage media, which are machine-, processor- or computer-readable and encode and/or contain machine-executable, processor-executable or computer-executable programs and instructions.

Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any computer system or type of hardware.

Furthermore, any of the software-based examples (comprising, for example, computer-executable instructions for causing a computer to perform any of the disclosed methods) can be uploaded, downloaded, or remotely accessed through a suitable communication means.

Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and sub-combinations with one another. The disclosed methods, apparatuses, and systems are not limited to any specific aspect or feature or combination thereof, nor do the disclosed examples require that any one or more specific advantages be present, or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A method, comprising:
determining varieties of a plurality of outputs of an application respectively corresponding to a plurality of identical inputs provided to the application; and
detecting, based on the varieties of the plurality of outputs, an Artificial Intelligence (AI) agent of the application, wherein the AI agent comprises an AI model providing AI-based resource information to the application to generate the plurality of outputs.

2. The method of claim 1, wherein the plurality of identical inputs are provided to the application over a first period of time.

3. The method of claim 1, wherein the varieties of the plurality of outputs comprise a first plurality of groups of varieties determined based on the first plurality of respective analysis methods performed on the plurality of outputs.

4. The method of claim 3, wherein the first plurality of respective analysis methods are performed on the plurality of outputs in parallel and/or in series.

5. The method of claim 1, wherein the application includes one or more functions, and wherein the AI-based resource information provided by the AI agent is used by at least one of the functions to generate outputs of the at least one of functions.

6. The method of claim 1, wherein the method further comprises:
determining whether the detected AI agent is to be managed.

7. The method of claim 6, wherein the determining whether the detected AI agent is to be managed comprises:
sending a plurality of requests over a second period of time to the AI agent, wherein the requests are for logic of making a decision;
receiving a plurality of pieces of logic of the AI agent on making the decision over the second period of time, wherein the plurality of piece of logic is responsive to the plurality of requests; and
determining, based on varieties of the plurality of pieces of logic, whether the detected AI agent is to be managed.

8. The method of claim 7, wherein the plurality of requests further require a plurality of pieces of configuration information of the detected AI agent over the second period of time, and wherein the requested plurality of pieces of configuration information are used together with the requested logic to determine whether the detected AI agent is to be managed.

9. The method of claim 6, wherein the determining whether the detected AI agent is to be managed comprises:
generating a baseline profile based on past behaviors of the detected AI agent; and determining whether the detected AI agent is to be managed based on current behaviors of the detected AI agent and the baseline profile.

10. The method of claim 1, wherein the method further comprises: assigning, based on security key deployment capability of an access controller of an AI model outside the network, a security key to the application.

11. The method of claim 10, wherein the assigning, based on security key deployment capability of an access controller of an AI model outside the network, a security key to the application comprises:
assigning, responsive to a capability of static security key deployment of the access controller, a static security key for the application.

12. The method of claim 11, wherein assigning a static security key to the application comprises:
assigning, by a key manager, a static security key for the application; encrypting the static security key; and
sending an encrypted static security key to the application, wherein the encrypted static security key is concealed from the application.

13. The method of claim 11, wherein assigning a static security key to the application comprises:
receiving, by a key proxy, an access request from the application; including, by the key proxy, the static security key assigned for the application into the access request; and
sending the access request including the static security key to a destination of the access request.

14. The method of claim 1, wherein the security key is an Application Program Interface (API) key.

15. A method, comprising:
determining security key assignment capability of an access controller of an Artificial Intelligence (AI) model outside an application; and
assigning, based on the security key assignment capability of an access controller, a security key to the application.

16. The method of claim 15, wherein the assigning, based on security key assignment capability of an access controller, the security key to the application comprises:
assigning, responsive to a capability of static security key assignment of the access controller, a static security key for the application.

17. The method of claim 16, wherein assigning a static security key to the application comprises:
assigning, by a key manager, a static security key for the application;
encrypting the static security key; and
sending an encrypted static security key to the application, wherein the encrypted static security key is concealed from the application.

18. The method of claim 17,
wherein the key manager is a local key manager that is in a machine where the application is running and provides a key assignment service only to applications running on the machine; or
wherein the key manager is a centralized key manager that provides a key assignment service to applications running on different machines.

19. The method of claim 16, wherein assigning a static security key to the application comprises:
receiving, by a key proxy, an access request for the application;
including, by the key proxy, the static security key assigned for the application into the access request; and
sending the access request including the static security key to a destination of the access request.

20. A non-transitory machine-readable storage medium including program code, when executed, to cause a machine to:
determine varieties of a plurality of outputs of an application respectively corresponding to a plurality of identical inputs provided to the application; and
detect, based on the varieties of the plurality of outputs, an Artificial Intelligence (AI) agent of the application, wherein the AI agent comprises an AI model providing AI-based resource information to the application to generate the plurality of outputs.
